(19) United States
(12) Patent Application Publication
(10) Pub. No.: US 2006/0151576 A1
(43) Pub. Date: Jul. 13, 2006

(54) Manufacturing method of butt joint, butt joint, manufacturing method of bent member, and friction stir joining method

(75) Inventors: Hiroshi Akiyama, Saitama-ken (JP); Masayuki Narita, Saitama-ken (JP); Yoshitaka Nagano, Tochigi (JP); Takenori Hashimoto, Tochigi (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: Honda Giken Kogyo Kabushiki Kaisha, Tokyo (JP); Showa Denko K.K., Tokyo (JP)

(21) Appl. No.: 10/519,412

(22) PCT Filed: Jul. 8, 2003
(86) PCT No.: PCT/JP03/08644

§ 371 Date: Jan. 20, 2006

Related U.S. Application Data
(60) Provisional application No. 60/470,502, filed on May 15, 2003.

(30) Foreign Application Priority Data
Jul. 8, 2002 (JP) 2002-198457

(51) Int. Cl. B23K 20/12; B23K 31/02

(52) U.S. Cl. 228/112.1

(57) ABSTRACT

Two joining members different in high temperature deformation resistance are disposed in an abutted manner. The rotational direction of a probe of a joining member is set to coincide with a rotational direction rotating from the joining member having lower high temperature deformation resistance toward the joining member having higher high temperature deformation resistance. Then, the rotating probe is inserted into the abutting portion of the joining members. The probe is advanced along the abutting portion with the probe inserted in the abutting portion to perform friction stir joining. As a result, a butt joint having high joining strength can be obtained.

### CROSS REFERENCE TO RELATED APPLICATIONS

This application is an application filed under 35 U.S.C. §111(a) claiming the benefit pursuant to 35 U.S.C. § 119(e) (1) of the filing date of Provisional Application No. 60/470,502 filed on May 15, 2003 pursuant to 35 U.S.C. §111(b).

Priority is claimed to Japanese Patent Application No. 2002-198457, filed on Jul. 8, 2002 and U.S. Provisional Patent Application No. 60/470,502, filed on May 15, 2003, the disclosure of which are incorporated by reference in their entireties.

### TECHNICAL FIELD

The present invention relates to a manufacturing method of a butt joint to be used as a metal member for use in transportation apparatuses, electrical household appliances, industrial machinery or the like, and also to such a butt joint. The present invention also relates to a friction stir joining (welding) method preferably used for manufacturing the butt joint and a manufacturing method of a bent member.

### BACKGROUND ART

The following description sets forth the inventor's knowledge of related art and problems therein and should not be construed as an admission of knowledge in the prior art.

In this specification, for the explanation purpose, one of the surfaces of joining members in the thickness direction into which a probe of a joining tool is inserted will be referred to as an “upper surface.”

Friction stir joining belongs to a category of solid welding and has such superior advantages that the type of metal members to be joined (welded) is not limited and the joining (welding) causes less distortion due to thermal stress in accordance with the joining. Therefore, in recent years, friction stir joining has been used as a joining means for manufacturing various structures.

The friction stir joining will be explained with reference to FIG. 6. In FIG. 6, the reference numeral “51” denotes a flat-shaped metallic first joining member and “52” denotes a flat-shaped metallic second joining member. The material of the first joining member 51 is different from that of the second joining member 52. The thickness t1′ of the first joining member 51 is set to be the same as the thickness t2′ of the second joining member 52 (i.e., t1′=t2′).

The following explanation will be made on the assumption that the high temperature deformation resistance Y2′ of the second joining member 2 is higher than the high temperature deformation resistance Y1′ of the first joining member 1 (i.e., Y1′<Y2′).

These two joining members 51 and 52 are disposed such that they are abutted against each other in a manner such that the rear and upper surfaces thereof are flush with each other, respectively. The abutting end surface of the first joining member 51 is formed to have uneven portions, and hence gaps 57 are formed at the abutting portion (joining portion) 53 of these joining members 51 and 52 in a state that both the joining members 51 and 52 are abutted against each other.

In FIG. 6, the reference numeral “60” denotes a joining tool for use in friction stir joining. This joining tool 60 is provided with a columnar rotor 61 and a pin-shaped probe 62 protruded from the end surface 61a of the rotor 61. The diameter of the end surface 61a of the rotor 61 is set to be larger than the diameter of the probe 62.

In order to join the abutting portion 53 of the joining members 51 and 52 using the joining tool 60, initially, the rotating probe 62 of the joining tool 60 is inserted in the abutting portion 53. Then, the probe 62 is advanced along the abutting portion 53 with the prove inserted in the abutting portion 53. By this, the abutted portion 53 will be joined (welded) at the probe inserted portion in accordance with the advance movement of the probe 62. In FIG. 6, the reference numeral “53′” denotes a joined portion (welded portion) joined (welded) by the probe 62, “55” denotes a friction stir joined portion (friction stir welded portion) formed in the joined portion 53′. “JD′” denotes the joining (welding) direction, which is the same direction as the moving (advancing) direction (MD′) of the probe 62 in this conventional example.

In the friction stir joining, a side of the joining members where the rotation direction L of the probe 62 coincides with the joining direction JD′ is referred to as an “advancing side,” and the other side thereof is referred to as a “retreating side.” At the retreating side, fewer frictional heat will be generated. To the contrary, at the advancing side, since a larger friction amount will be generated in the joining member, an undercut portion (not shown) will be generated on the upper surface of the friction stir joined portion 55 at the portion of the joining member 51 located at the advancing side. In FIG. 6, “AD” denotes the advancing side, and “RE” denotes the retreating side.

In the friction stir joining, when the joining is performed in such a manner that the rotational direction of the probe 12 at the back side of the joining direction JD′ coincides with the direction L rotating from the second joining member 52 toward the first joining member 51, the following problems will arise.

As explained above, since the amount of frictional heat generated at the retreating side is fewer the second joining member 52 located at the retreating side is hard to be softened. Furthermore, since the second joining member 52 has high temperature deformation resistance Y2′ higher than the high temperature deformation resistance Y1′ of the first joining member 51, the second joining member 52 is harder to be softened. As a result, the rear surface stir region width H′ (the width of the rear surface of the friction joined portion 55) becomes narrower, which may cause a remain of the gaps 57 at the abutting portion 53. If the gaps 57 remain, the joint strength (e.g., bending strength, tensile strength) of the butt joint deteriorates. Accordingly, in cases where this butt joint is used as, for example, a bending material, the bending cannot be performed as intended.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### DISCLOSURE OF INVENTION

The present invention is made in view of the aforementioned technical background.

It is an object of the present invention to provide a manufacturing method of a butt joint capable of increasing a rear surface stir region width (a width of a rear surface of a joined portion) and joint strength.

It is another object of the present invention to provide a butt joint manufactured by the aforementioned method, a manufacturing method of a bent member using the method for manufacturing the butt joint and a friction stir joining method preferably used for manufacturing the butt joint.

According to the first aspect of the present invention, a manufacturing method of a butt joint, includes:

disposing two joining members different in high temperature deformation resistance so as to abut against each other; and

performing friction stir joining by advancing a rotating probe of a joining tool along an abutting portion of the joining members with the rotating probe inserted in the abutting portion, wherein the friction stir joining is performed in a state in which a rotational direction of the probe of the joining tool is set so as to coincide with a rotational direction rotating from one of the joining members having a lower high temperature deformation resistance toward the other of the joining members having a higher high temperature deformation resistance at a back side of a joining direction.

In the first aspect of the present invention, by setting the rotational direction of the probe of the joining tool so as to coincide with a rotational direction rotating from one of the joining members having a lower high temperature deformation resistance toward the other of the joining members having a higher high temperature deformation resistance at the back side of the joining direction, the joining member of lower high temperature deformation resistance is located at the treating side. Therefore, the joining member is easily softened, resulting in an increased rear surface stir region width (i.e., the width of the rear surface of the joined portion). As a result, even in cases where gaps are formed in the abutting portion of the joining members, the gaps can be assuredly filled with the materials of the joining members, which in turn can improve the joint strength of the obtained butt joint. Furthermore, since the rear surface stir region width increases, even if the probe insertion is not positioned accurately to the abutting portion at the time of joining, the abutting portion can be joined in a good manner, resulting in an improved joining operation.

In the present invention, the comparison of the high temperature deformation resistance of the joining members is performed based on the deformation resistance at the joining temperature. Concretely, in cases where both the joining members are made of aluminum or its alloy, the comparison is preferably performed based on the mean deformation resistance within the range of 200 to 600° C., more preferably 400 to 550° C. In this case, the rear surface stir region width can be increased assuredly.

In the present invention, as the joining members, for example, metal members can be used. Especially, aluminum or its alloy, cupper or its alloy can be preferably used.

According to the second aspect of the present invention, a manufacturing method of a butt joint, comprises:

disposing two joining members same in material but different in thickness so as to abut against each other with a step formed on upper surface sides of the joining members; and

performing friction stir joining by advancing a rotating probe of a joining tool along an abutting portion of the joining members with the rotating probe inserted in the abutting portion,

wherein the friction stir joining is performed in a state in which a rotational direction of the probe of the joining tool is set so as to coincide with a rotational direction rotating from one of the joining members having a thinner thickness toward the other of the joining members having a thicker thickness at a back side of a joining direction.

In the second aspect of the present invention, by setting the rotational direction of the probe of the joining tool so as to coincide with a rotational direction rotating from one of the joining members having a thinner thickness toward the other of the joining members having a thicker thickness at the back side of the joining direction, the thinner joining member is positioned at the retreating side, resulting in an increased rear surface stir region width. Accordingly, the same function as in the first aspect of the present invention can be obtained.

According to the third aspect of the preset invention, a manufacturing method of a butt joint, comprises:

preparing a first joining member of a high temperature deformation resistance Y1 and a thickness t1 and a second joining member of a high temperature deformation resistance Y2 and a thickness t2; and

performing friction stir joining by advancing a rotating probe of a joining tool along an abutting portion of the joining members with the rotating probe inserted in the abutting portion,

wherein, in cases where the joining members are disposed in an abutted manner in a state in which the joining members meet a relation of (Y1×t1)>(Y2×t2), the friction stir joining is performed in a state in which a rotational direction of the probe of the joining tool is set so as to coincide with a rotational direction rotating from the second joining member toward the first joining member at a back side of a joining direction, and wherein, in cases where the joining members are disposed in an abutted manner in a state in which the joining members meet a relation of (Y1×t1)<(Y2×t2), the friction stir joining is performed in a state in which a rotational direction of the probe of the joining tool is set so as to coincide with a rotational direction rotating from the first joining member toward the second joining member at the back side of the joining direction.

In the third aspect of the present invention, by setting the rotational direction of the probe taking into account of both the high temperature deformation resistance and the thickness of the joining members, the rear surface stir region width can be increased.

In the first to third aspects of the present invention, it is preferable that the butt joint is a member to be used as a bending work material.

Furthermore, in the first to third aspects of the present invention, it is preferable that the butt joint is a member to be used as a tailored blank member for manufacturing automobile parts.

According to the fourth aspect of the preset invention, a butt joint is excellent in bendability and obtained by the manufacturing method recited in any one of the aforementioned first to third aspects of the present invention.

With the fourth aspect of the present invention, in the butt joint obtained by the manufacturing method of the butt joint according to one of the first to third aspects of the present invention, the gaps formed in the abutting portion are assuredly filled with the materials of the joining members. Therefore, the butt joint is excellent in bendability. As a result, by performing bending operation to the butt joint, the generation of bending work defects can be prevented, resulting in a high quality bent member.

According to the fifth aspect of the present invention, a manufacturing method of a bent member performs a bending operation to the butt joint obtained by the manufacturing method recited in any one of the aforementioned first to third aspects of the present invention.

With this manufacturing method, a bent member of high quality can be obtained by the same reasons as in the fourth aspect of the present invention.

In the fifth aspect of the present invention, the type of bending work is not limited to a specific one, and the bending work can be press bending work or various bending work using press dies, dies or rolls.

According to the sixth aspect of the present invention, a butt joint is a joint formed by integrally joining two joining members abutted against each other by a friction stir joining method, wherein one of the joining members has a high temperature deformation resistance Y1 and a thickness t1 and the other of the joining members has a high temperature deformation resistance Y2 and a thickness t2, and

wherein an undercut portion is formed on a surface of a friction stir joined portion at a side of one of the joining members having a larger value of (Y1×t1) or (Y2×t2).

With this butt joint, since the undercut portion is formed on the surface of the friction stir joined portion at a side of one of the joining members having a larger value (Y1×t1) or (Y2×t2), less influence is given to the joint strength by the undercut portion, causing almost no deterioration of the joint strength. Accordingly, the butt joint is excellent in joint strength.

The butt joint according to the sixth aspect of the present invention can be assuredly obtained by the manufacturing method of a butt joint according to any one of the first to third aspects of the present invention. Furthermore, the butt joint according to the sixth aspect of the present invention can be assuredly obtained by the friction stir joining according to any one of the seventh to ninth aspects of the present invention.

In the sixth aspect of the present invention, in cases where undercut portions are formed on the surface of the friction stir joined portion at both sides of the joining member having a larger value of (Y2×t2) and the joining member having a smaller value of (Y1×t1), it is preferable that the undercut portion formed on the surface of the friction stir joined portion at the side of the joining member having the larger value is relatively larger than the undercut portion formed on the surface of the friction stir joined portion at the side of the joining member having the smaller value.

In the sixth aspect of the present invention, it is preferable that the butt joint is a member to be used as a bending work material.

In the sixth aspect of the present invention, it is preferable that the butt joint is a member to be used as a tailored blank member for manufacturing automobile parts.

According to the seventh aspect of the present invention, a friction stir joining method, comprises:

disposing two joining members different in high temperature deformation resistance so as to abut against each other; and

performing friction stir joining by advancing a rotating probe of a joining tool along an abutting portion of the joining members with the rotating probe inserted in the abutting portion,

wherein the friction stir joining is performed in a state in which a rotational direction of the probe of the joining tool is set so as to coincide with a rotational direction rotating from one of the joining members having a lower high temperature deformation resistance toward the other of the joining members having a higher high temperature deformation resistance at a back side of a joining direction.

In the seventh aspect of the present invention, the same function as in the first aspect of the present invention can be obtained.

According to the eighth aspect of the present invention, a friction stir joining method, comprises:

disposing two joining members same in material but different in thickness so as to abut against each other with a step formed on surface sides of the joining members; and

performing friction stir joining by advancing a rotating probe of a joining tool along an abutting portion of the joining members with the rotating probe inserted in the abutting portion,

wherein the friction stir joining is performed in a state in which a rotational direction of the probe of the joining tool is set so as to coincide with a rotational direction rotating from one of the joining members having a thinner thickness toward the other of the joining members having a thicker thickness at a back side of a joining direction.

In the eighth aspect of the present invention, the same function as in the second aspect of the present invention can be obtained.

According to the ninth aspect of the present invention, a friction stir joining method, comprises:

preparing a first joining member of a high temperature deformation resistance Y1 and a thickness t1 and a second joining member of a high temperature deformation resistance Y2 and a thickness t2; and

performing friction stir joining by advancing a rotating probe of a joining tool along an abutting portion of the joining members with the rotating probe inserted in the abutting portion,

wherein, in cases where the joining members are disposed in an abutted manner in a state in which the joining members meet a relation of (Y1×t1)>(Y2×t2), the friction stir joining is performed in a state in which a rotational direction of the probe of the joining tool is set so as to coincide with a rotational direction rotating from the second joining member toward the first joining member at a back side of a joining direction, and

wherein, in cases where the joining members are disposed in an abutted manner in a state in which the joining members meet a relation of (Y1×t1)<(Y2×t2), the friction stir joining is performed in a state in which a rotational direction of the probe of the joining tool is set so as to coincide with a rotational direction rotating from the first joining member toward the second joining member at a back side of the joining direction.

In the ninth aspect of the present invention, the same function as in the third aspect of the present invention can be obtained.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF DRAWINGS

FIG. 1 is an explanatory view of a manufacturing method of a butt joint showing the state in which a joining operation is in progress according to the first embodiment of the present invention;

FIG. 2 is a perspective view showing the state in which bending work is executed to the butt joint obtained by the manufacturing method;

FIG. 3 is an explanatory view of a manufacturing method of a butt joint showing the state in which a joining operation is in progress according to the second embodiment of the present invention;

FIG. 4 is an enlarged cross-sectional view taken along the line A-A in FIG. 3;

FIG. 5 is an enlarged cross-sectional view taken along the line B-B in FIG. 3; and

FIG. 6 is an explanatory view of a manufacturing method of a butt joint showing the state in which a joining operation is in progress according to a conventional manufacturing method of a butt joint.

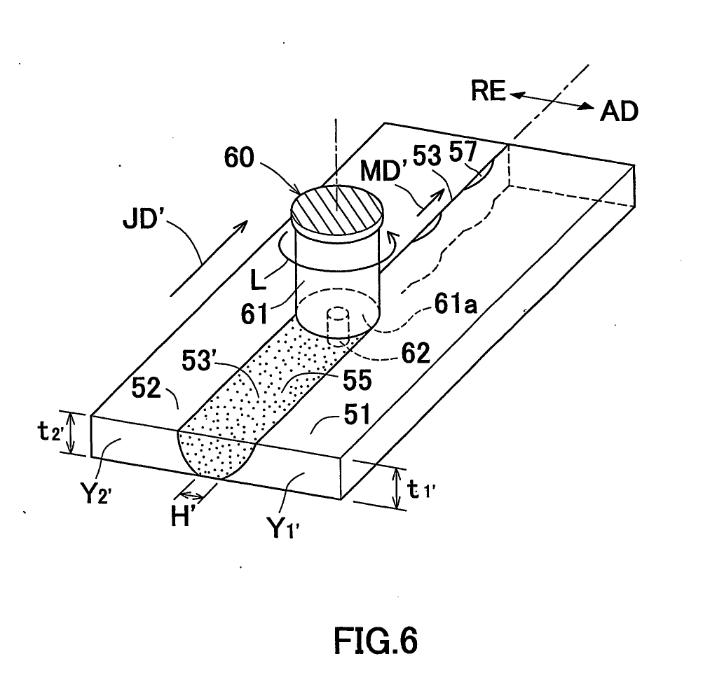

### BEST MODE FOR CARRYING OUT THE INVENTION

Preferable embodiments of the present invention will be described in detail with reference to the attached drawings.

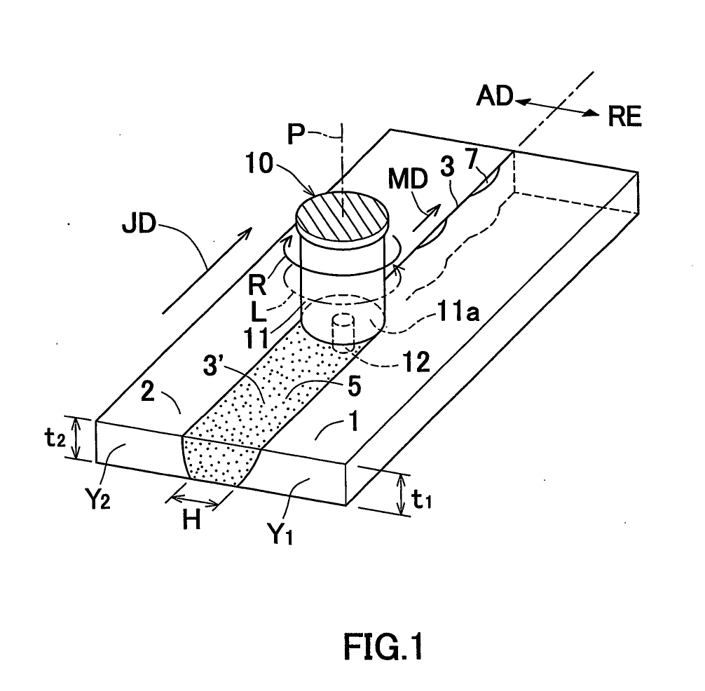

FIG. 1 shows an explanatory view showing the manufacturing method of a butt joint according to the first embodiment of the present invention.

In FIG. 1, the reference numeral “1” denotes a plate-like first joining member, “2” denotes a plate-like second joining member.

Hereinafter, it is assumed that the high temperature deformation resistance of the first joining member 1 is “Y1,” and the thickness is “t1.” Also, it is assumed that the high temperature deformation resistance of the second joining member 2 is “Y2,” and the thickness is “t2.”

In the first embodiment, the thickness t1 of the first joining member 1 and the thickness t2 of the second joining member 2 are set to be the same (i.e., t1=t2).

On the other hand, the material of the first joining member 1 and that of the second joining member 2 are different from each other. Accordingly, the high temperature deformation resistance Y1 of the first joining member 1 and the high temperature deformation resistance Y2 of the second joining member 2 are different from each other (i.e., Y1≠Y2). In detail, the high temperature deformation resistance Y2 of the second joining member 2 is set to be higher than the high temperature deformation resistance Y1 of the first joining member 1 (i.e., Y1<Y2).

As a result, when the product (Y1×t1) of the high temperature deformation resistance Y1 of the first joining member 1 and the thickness t1 is compared with the product (Y2×t2) of the high temperature deformation resistance Y2 of the second joining member 2 and the thickness t2, the value of (Y2×t2) is larger than that of (Y1×t1) (i.e., (Y1×t1)<(Y2×t2)).

In this first embodiment, the first joining member 1 and the second joining member 2 are made of aluminum or its alloy different from each other in material.

These two joining members 1 and 2 are disposed in such a manner that corresponding end surfaces of the joining members 1 and 2 are abutted against each other with their rear surfaces and upper surfaces flush with each other, respectively. In this abutted state, both the joining members 1 and 2 are supported by a supporting member (not shown) from their rear surfaces. Furthermore, on the rear surface of the abutting portion 3 of these joining members 1 and 2, a backing member (not shown) is attached.

At least one of the joining members 1 and 2 (in the embodiment shown in FIG. 1, the first joining member 1) has an uneven abutting end surface generated by the cutting processor the like. Therefore, in the state in which both the joining members 1 and 2 are abutted against each other, gaps 7 due to the uneven abutting end surface are formed at the abutting portion 3 of the joining members 1 and 2. In FIG. 1, please note that the gaps 7 are shown with exaggeration for the purpose of illustration.

In FIG. 1, the reference numeral “10” denotes a joining tool for friction stir joining. This tool 10 is provided with a columnar rotor 11 and a pin-shaped probe 12 protruded from the end surface 11a of the rotor 11. The diameter of the end surface 11a of the rotor 11 is set to be larger than the diameter of the probe 12. The rotor 11 and the probe 12 are made of heat-resistant material which is harder than both the joining members 1 and 2 and capable of resisting frictional heat which will be generated during the joining processing. On the external surface of the probe 12, stirring protrusions (not shown) for stirring the materials of the joining members 1 and 2 softened by frictional heat are formed in a spiral manner.

In this joining tool 10, at least the external peripheral end portion of the rotor 11 exists on the plane perpendicular to the rotational axis P. In this embodiment, the end surface 11a of the rotor 11 is formed into a flat shape. In the present invention, however, the end surface 11a of the rotor 11 can be formed into a concave shape inwardly dented from the external end periphery to the rotational central portion.

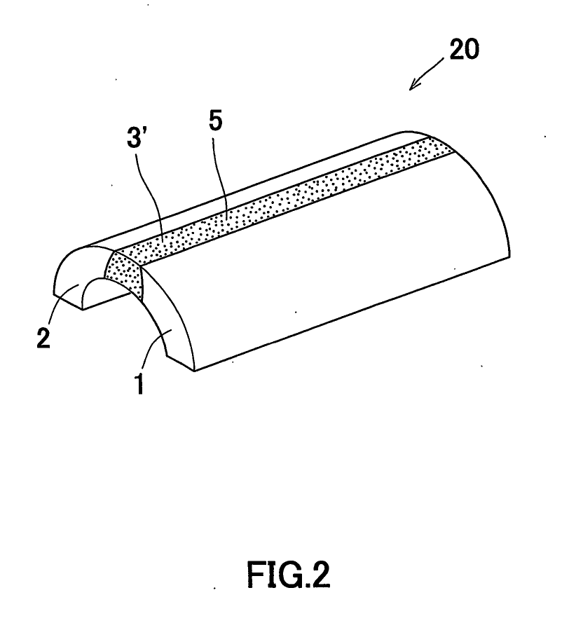

Next, a method for joining the abutting portion 3 of the joining members 1 and 2 using the joining tool 10 will be explained. In this embodiment, a butt joint 20 to be obtained by this method will be subjected to a bending work (see FIG. 2). Concretely, the butt joint 20 can be used as a tailored blank member for manufacturing various automobile parts (e.g., door inner panels, flames, pillars, automobile bodies). In the present invention, however, the butt joint 20 is not limited to a member used as a bending work material or a tailored blank material.

Initially, as shown in FIG. 1, the rotor 11 and the probe 12 of the joining tool 10 are rotated about the center of the rotational axis P in the predetermined rotational direction (this rotational direction will be detailed later). Then, the rotating probe 12 is inserted into the abutting portion 3 of the joining members 1 and 2 from the upper surface sides thereof. Furthermore, the end surface 11a of the rotor 11 is disposed so as to be pressed on the surface of the joining members 1 and 2. The insertion of the probe 12 into the abutting portion 3 can be performed from one longitudinal end of the joining members 1 and 2.

From this state, the probe 12 is advanced along the abutting portion 3 of the joining members 1 and 2. In accordance with this advance movement, the abutting portion 3 of the joining members 1 and 2 at the probe insertion portion will be joined (welded) sequentially along the abutting portion 3 by the probe 12. In FIG. 1, the reference numeral “3′” denotes an abutting portion joined (welded) by the probe 12, and “5” denotes a friction stir joined (welded) portion formed at the abutting portion 3′. “MD” denotes the moving (traveling) direction of the probe 12. In this embodiment, the moving direction MD of the probe 12 coincides with the joining direction “JD.”

Now, the rotational direction of the prove 12 of the joint tool 10 will be explained.

In this embodiment, as mentioned above, the joining members 1 and 2 are disposed in an abutted manner in the condition in which the relational expression of (Y1×t1)<(Y2×t2) is met. Therefore, the rotational direction of the probe 12 at the behind of the joining direction JD is set to the rotational direction rotating from the first joining member 1 toward the second joining member 2. Then, while rotating the rotor 11 and the probe 12 in the rotational direction R, the probe 12 is inserted into the abutting portion 3 of the joining members 1 and 2. Subsequently, the probe 12 is advanced along the abutting portion 3.

As a result, by the friction heat generated due to the rotation of the probe 12 and the friction heat generated by the friction between the end surface 11a of the rotor 11 and the upper surfaces of the joining members 1 and 2, the joining members 1 and 2 are softened at the probe insertion portion and its vicinity. The softened material of the joining members 1 and 2 is stirred by the rotational force of the probe 12. Then, the softened material goes around the probe 12 to fill the groove formed by the advancing probe 12 and solidifies quickly by releasing the frictional heat. This phenomena is sequentially repeated in accordance with the advance movement of the probe 12, thereby joining the joining members 1 and 2 along the probe traveling portion, which causes an integral joint of the joining members 1 and 2.

In the aforementioned friction stir joining method, the first joining member 1 is disposed at the retreating side RE, and the value of (Y1×t1) of the first joining member 1 is smaller than the value of (Y2×t2) of the second joining member 2 (i.e., (Y1×t1)<(Y2×t2)) as mentioned above. Accordingly, the first joining member 1 can be softened easier than the second joining member 2. As a result, the rear surface stir region width H (i.e., the width of the rear surface of the joined portion 5) increases. Therefore, the gaps 7 generated at the abutting portion 3 of the joining members 1 and 2 can be assuredly filled with the materials of the joining members 1 and 2. Thus, the butt joint 20 obtained by the aforementioned manufacturing method has high joint strength.

FIG. 2 is a perspective view showing the butt joint 20 to which U-shape pressing (or V-shaped pressing) was executed by using a known press machine. In this embodiment shown in FIG. 2, the butt joint 20 is bent into a U-shape cross-section (or V-shaped cross-section) along the friction stir joined portion 5 such that the rear surface of the joined portion 5 faces towards outside. As mentioned above, in the butt joint 20, the gaps 7 generated in the abutting portion 3 are assuredly filled with the materials of the joining members 1 and 2, and therefore the but joint has high joint strength. As a result, in cases where U-shaped press bending is executed against the butt joint 20, no bending defect such as cracks will not be generated in the joined portion 5, which enables to obtain a high quality bent member. Thus, the butt joint 20 can be used especially as a tailored blank member for automobiles.

In the present invention, bending is not limited to U-shaped bending (or V-shaped bending), and various bending can be employed.

According to the manufacturing method of this butt joint, since the rear surface stir region width H can be increased, the joining of the abutting portion 3 can be performed in a good condition without exactly setting the insertion position of the probe 12 to the abutting portion 3. This enables an efficient joining operation.

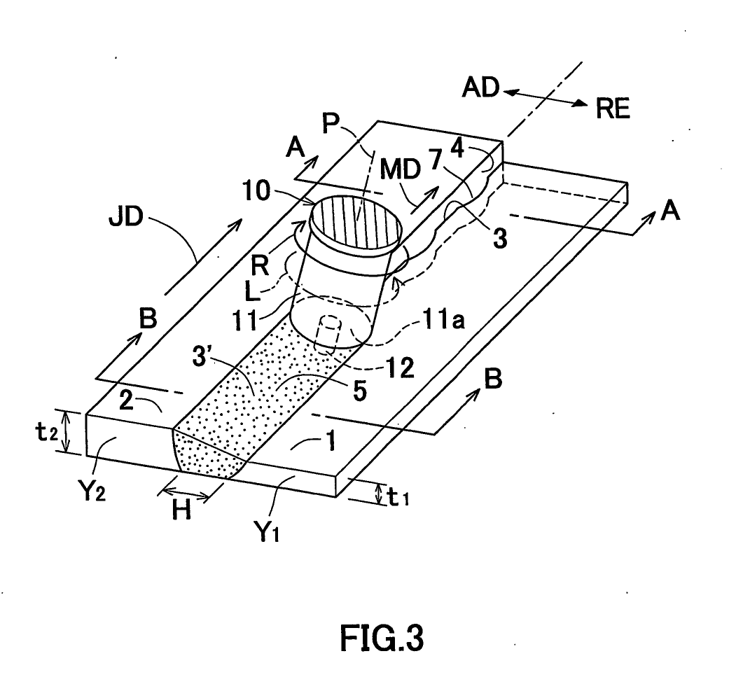

FIGS. 3 to 5 illustrate a manufacturing method of a butt joint according to the second embodiment of the present invention. In these figures, the same reference numerals as in the first embodiment are allotted to the corresponding portions. Hereinafter, the differences between the second embodiment and the first embodiment will be mainly explained.

In this second embodiment, the thickness t1 of the first joining member 1 and the thickness t2 of the second joining member 2 are different from each other (i.e., t1≠t2). In detail, the thickness t2 of the second joining member 2 is set to be thicker than the thickness t1 of the first joining member 1 (i.e., t1<t2).

On the other hand, the material of the first joining member 1 and that of the second joining member 2 are the same (i.e., Y1=Y2).

As a result, when the product (Y1×t1) of the high temperature deformation resistance Y1 of the first joining member 1 and the thickness t1 is compared with the product (Y2×t2) of the high temperature deformation resistance Y2 of the second joining member 2 and the thickness t2, the value of (Y2×t2) is larger than that of (Y1×t1) (i.e., (Y1×t1)<(Y2×t2)).

In this second embodiment, the first joining member 1 and the second joining member 2 are made of aluminum or its alloy of the same material.

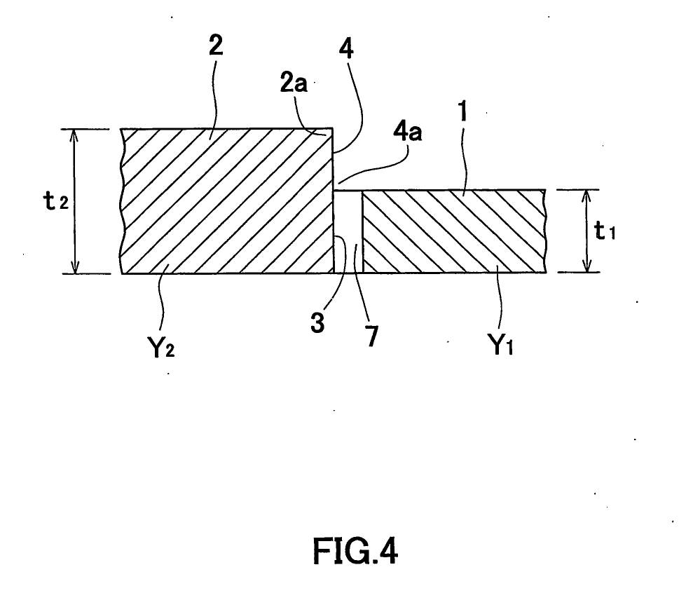

These two joining members 1 and 2 are disposed in such a manner that corresponding end surfaces of the joining members 1 and 2 are abutted against each other with their rear surfaces flush with each other. Thus, a stepped portion corresponding to the difference of the thickness is formed on the upper surface sides of the joining members 1 and 2. In FIG. 4, the reference numeral “4” denotes the stepped portion, and “4a” denotes the corner portion of the stepped portion 4.

The remaining structure of these joining members 1 and 2 is the same as that of the first embodiment. That is, in FIGS. 3 and 4, the reference numeral “7” denotes a gap formed at the abutting portion 3 of the joining members 1 and 2.

The structure of the joining tool 10 is the same as in the first embodiment, and hence the overlapping explanation will be omitted.

Next, a method for joining the abutting portion 3 of the joining members 1 and 2 using the joining tool 10 will be explained.

Initially, the rotor 11 and the probe 12 of the joining tool 10 are rotated about the center of the rotational axis P in the predetermined rotational direction (this rotational direction will be detailed later). Then, the rotating probe 12 is inserted into the abutting portion 3 of the joining members 1 and 2 from the upper surface sides thereof with the rotating probe 12 inclined toward the first joining member side. Furthermore, the end surface 11a of the rotor 11 is disposed so as to be pressed on the surface of the joining members 1 and 2. In this second embodiment, the end surface 11a of the rotator 11 is disposed so as to be pressed onto the shoulder portion (see FIG. 4, “2a”) protruded upwardly from the abutting portion 3. The insertion of the probe 12 into the abutting portion 3 can be performed from one longitudinal end of the joining members 1 and 2. Furthermore, after inserting the probe 12 into the abutting portion 3, the rotational axis P can be inclined toward the first joining member side. Alternatively, without inclining the rotational axis P, the aforementioned inclined state can be realized by inclining the joining members 1 and 2.

From this state, the probe 12 is advanced along the abutting portion 3 of the joining members 1 and 2. In accordance with this advance movement, the abutting portion 3 of the joining members 1 and 2 at the probe insertion portion will be joined (welded) sequentially along the abutting portion 3 by the probe 12.

As a result, by the friction heat generated due to the rotation of the probe 12 and the friction heat generated by the friction between the end surface 11a of the rotor 11 and the shoulder portion 2a of the second joining member 2, the joining members 1 and 2 are softened at the probe insertion portion and its vicinity. Furthermore, the shoulder portion 2a of the second joining member 2 is pressed by the end surface 11a of the rotor 11 and therefore the surface of the shoulder portion 2a is plastically deformed into an inclined surface. Due to the plastic deformation of the shoulder portion 2a, a part of the material of the shoulder portion 2a will fill the corner portion 4a of the stepped portion 4.

The softened material of the joining members 1 and 2 by the friction heat is stirred by the rotational force of the probe 12 with the shoulder portion 2a being deformed. Then, the softened material goes around the probe 12 to fill the groove formed by the advancing probe 12 and solidifies quickly by releasing the frictional heat. This phenomena is sequentially repeated in accordance with the advance movement of the probe 12, thereby joining the joining members 1 and 2 along the probe traveling portion, which causes an integral joint of the joining members 1 and 2.

Now, the direction of rotation of the prove 12 of the rotor 10 will be explained.

In this second embodiment, as mentioned above, the joining members 1 and 2 are disposed in an abutted manner in the condition in which the relational expression of (Y1×t1)<(Y2×t2) is met.

Therefore, the rotational direction of the probe 12 at the back side of the joining direction JD is set to the rotational direction rotating from the first joining member 1 toward the second joining member 2. Then, while rotating the rotor 11 and the probe 12 in the rotational direction R, the probe 12 is advanced along the abutting portion 3 to perform the aforementioned friction stir joining.

In the friction stir joining method, the first joining member 1 is disposed at the retreating side RE, and the value of (Y1×t1) of the first joining member 1 is smaller than the value of (Y2×t2) of the second joining member 2 (i.e., (Y1×t1)<(Y2×t2)). Accordingly, the first joining member 1 can be softened easier than the second joining member 2. As a result, the rear surface stir region width H increases. Therefore, the gaps 7 generated at the abutting portion 3 of the joining members 1 and 2 can be assuredly filled with the materials of the joining members 1 and 2. Thus, the butt joint 20 obtained by the aforementioned manufacturing method has high joint strength in the same manner as in the first embodiment. Furthermore, even in cases where U-shaped press bending (or V-shaped press bending) by using a known press machine is executed to the butt joint, almost no forming defaults will generate at the joined portion 5, which enables a high quality bent member.

Especially, this manufacturing method of the butt joint has the following superior advantages. That is, as mentioned above, the end surface 11a of the rotor 11 of the joining tool 10 is disposed with the end surface inclined toward the first joining member 1 and the end surface 11a of the rotor 11 is disposed so as to be pressed on the shoulder portion 2a of the second joining member 2. Therefore, the surface of the joined portion 5 is formed into an inclined surface bridging the upper surface of the first joining member 1 and that of the second joining member 2. As a result, even in cases where bending processing is executed to this butt joint, the stress concentration, which tends to be generated at the stepped portion (see FIG. 4, “4”) at the time of bending, can be decreased. Accordingly, the butt joint is extremely excellent in bending workability. Therefore, in cases where bending is executed to this butt joint, a bent member having extremely high quality can be obtained.

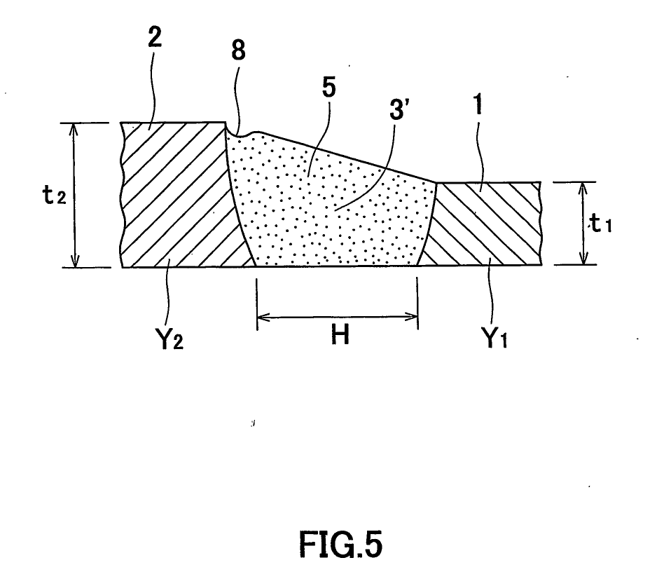

Furthermore, as shown in FIG. 5, in this but joint, an undercut portion 8 is formed at a portion adjacent to the second joining member 2 on the surface of the joined portion 5. However, since the value of (Y2×t2) of the second joining member 2 is larger than the value of (Y1×t1) of the first joining member 1, in this butt joint, the undercut portion 8 gives less influence to the joint strength, resulting in almost no deterioration of the joint strength. Thus, this butt joint maintains the superior joint strength. In FIG. 5, the undercut portion 8 is illustrated with exaggeration for the explanation purpose.

Another advantages of the manufacturing method of the butt joint of this second embodiment are the same as in the first embodiment, and therefore the explanation will be omitted.

In the aforementioned manufacturing methods of the first and second embodiments, both the joining members 1 and 2 are disposed in a state that the relational expression of (Y1×t1)<(Y2×t2) is satisfied. To the contrary, however, in cases where the joining members 1 and 2 are disposed in a state that the relational expression of (Y1×t1)>(Y2×t2) is satisfied, the rotational direction of the probe 12 at the back side of the joining direction JD is set so as to coincide with the rotational direction rotating from the second joining member 2 toward the first joining member 1. This enables to obtain the aforementioned effects. The joining method in this case is the same as in the first and second embodiments, and hence the overlapping explanation will be omitted.

The present invention is not limited to the aforementioned embodiments, and can be changed in various manners.

For example, in the aforementioned embodiments, the joining of the abutted portion 3 of the first and second joining members 1 and 2 is performed by advancing the rotating probe 12 inserted in the abutting portion 3 from the upper surface side of the joining members 1 and 2 with the first and second joining members 1 and 2 fixed. In the present invention, however, the joining of the abutted portion 3 of the first and second joining members 1 and 2 can be performed by advancing the first and second joining members 1 and 2 against the rotating probe 12 with the rotating probe 12 inserted in the abutting portion 3 from the upper surface side of the joining members 1 and 2 fixed. In this case, the direction opposite to the advancing direction of the joining members 1 and 2 is the joining direction.

Next, concrete examples and reference examples will be explained.

### EXAMPLE 1

A flat plate-shaped aluminum alloy first joining member(JIS-A6061-T6, thickness t1=2 mm) and a flat plate-shaped aluminum alloy second joining member (JIS-A5083-O, thickness t2=2 mm) were prepared.

It is generally known that the mean deformation resistance of A6061-T6 in the temperature range of 400 to 550° C. is lower than that of A5083-O in the same temperature range. Accordingly, in the aforementioned temperature range, the product of the high temperature deformation resistance Y1 and the thickness T1 of the first joining member 1, i.e., the value (Y1×t1), is smaller than the product of the high temperature deformation resistance Y2 and the thickness t2 of the second joining member 2, i.e., the value (Y2×t2) (i.e., (Y1×t1)<(Y2×t2)).

On the other hand, as a joining tool 10, a joining tool having an end surface 11a of a rotor 11 whose diameter is 12 mm and a probe 12 having a diameter of 5 mm was prepared.

The aforementioned joining members 1 and 2 were disposed in an abutted manner with the rear surfaces thereof and the upper surfaces thereof flush with each other, respectively. Then, the rotational direction of the rotor 11 of the joining tool 10 and that of the probe 12 were set so as to coincide with the rotational direction R rotating from the first joining member 1 toward the second joining member 2 at the back side of the joining direction JD. Then, in accordance with the joining procedures shown in the first embodiment, the abutting portion 3 of the joining members 1 and 2 was joined.

Accordingly, in this example 1, the first joining member 1 was located at the retreating side RE and the second joining member 2 was located at the advancing side.

### COMPARATIVE EXAMPLE 1

The rotational direction of the rotor 11 of the joining tool 10 and that of the probe 12 were set so as to coincide with the rotational direction rotating from the second joining member 2 toward the first joining member 1 at the back side of the joining direction JD, and the abutting portion 3 of the first joining member 1 and the second joining member 2 was joined. The other joining conditions were the same as in the example 1.

Accordingly, in this comparative example 1, the second joining member 2 was located at the retreating side RE and the first joining member 1 was located at the advancing side.

### EXAMPLE 2

A flat plate-shaped aluminum alloy first joining member(JIS-A5052-O, thickness t1=1 mm) and a flat plate-shaped aluminum alloy second joining member (JIS-A5052-O, thickness t2=2 mm) were prepared.

Since the material of the first joining member 1 and that of the second joining member 2 are the same, the value (Y1×t1) of the first joining member 1 was smaller than the value of (Y2×t2) (i.e., (Y1×t1)<(Y2×t2)).

The aforementioned joining members 1 and 2 were disposed in an abutted manner with the rear surfaces thereof flush with each other. Then, the rotational direction of the rotor 11 of the joining tool 10 and that of the probe 12 were set so as to coincide with the rotational direction R rotating from the first joining member 1 toward the second joining member 2 at the back side of the joining direction JD. Then, in accordance with the joining procedures shown in the second embodiment, the abutting portion 3 of the joining members 1 and 2 was joined. As the joining tool, the same joining tool as in the first embodiment was used.

Accordingly, in this second example 2, the first joining member 1 was located at the retreating side RE and the second joining member 2 was located at the advancing side.

### COMPARATIVE EXAMPLE 2

The rotational direction of the rotor 11 of the joining tool 10 and that of the probe 12 were set so as to coincide with the rotational direction rotating from the second joining member 2 toward the first joining member 1 at the back side of the joining direction JD, and the abutting portion 3 of the first joining member 1 and the second joining member 2 was joined. The other joining conditions were the same as in the example 2.

Accordingly, in this comparative example 2, the second joining member 2 was located at the retreating side RE and the first joining member 1 was located at the advancing side.

[Joined Results]

Each rear surface stir region width H of each of the butt joints obtained by the example 1, the comparative example 1, the example 2 and the comparative example 2 was measured. These results are shown in Table 1.

TABLE 1

| | | | | | Rear surface |
|---|---|---|---|---|---|
| | Retreating side | | Advancing side | | stir region |
| | Material | Thickness | Material | Thickness | width H |
| Example 1 | A6061-T6 | 2 mm | A5058-O | 2 mm | 3.1 mm |
| Comp. | A5083-O | 2 mm | A6061-T6 | 2 mm | 2.5 mm |
| Example 1 | | | | | |
| Example 2 | A5052-O | 1 mm | A5052-O | 2 mm | 3.8 mm |
| Comp. | A5052-O | 2 mm | A5052-O | 1 mm | 3.0 mm |
| Example 2 | | | | | |

As shown in Table 1, the rear surface stir region width H of each of the butt joints obtained Example 1 and Example 2 is larger than that of each of the butt joints obtained Comparative Example 1 and Comparative Example 2. Accordingly, it is confirmed that the manufacturing method of the butt joint according to the present invention can increase the rear surface stir region width H.

Furthermore, although U-shaped press is executed to the respective butt joints obtained in Example 1 and Example 2, no working defect was generated, and a high quality bent member was obtained.

The effects of the present invention can be summarized as follows.

According to the first aspect of the present invention, since the friction stir joining is performed with the rotational direction of the probe of the joining tool coincided with the predetermined direction, the rear surface stir region width (rear surface width of the joined portion) can be increased. Therefore, even in cases where gaps are formed in the abutting portion of the joining members, the gaps can be assuredly filled with the materials of the joining members, which in turn can improve the joint strength of the butt joint. Furthermore, since the rear surface stir region width can be increased, even if the probe insertion is not correctly positioned to the abutting portion at the time of joining, the abutting portion can be joined in a good manner, resulting in efficient joining operation.

According to the second aspect of the present invention, the same effects as in the first aspect of the present invention can be obtained.

According to the third aspect of the present invention, since the rotational direction of the probe is set in view of both the high temperature deformation resistance and the thickness of the joining members, the rear surface stir region width can be increased assuredly. Accordingly, the joining strength of the butt joint can be increased assuredly, and the joining operation can be performed more efficiently.

According to the fourth aspect of the present invention, the generation of bending work defects can be prevented assuredly, causing a high quality bent member.

According to the fifth aspect of the present invention, a high quality bent member can be obtained.

According to the sixth aspect of the present invention, an undercut portion is formed at the portion of the joining member whose product of Y1(Y2) and t1(t2) is larger than the product of Y2(Y1) and t2(t1) of the other joining member on the friction stir joint surface, there is less influence to the joining strength due to the undercut portion, causing less deterioration of the joining strength. As a result, a butt joint having excellent joint strength can be provided.

According to the seventh aspect of the present invention, the same effects as in the first embodiment can be obtained.

According to the eighth aspect of the present invention, the same effects as in the second embodiment can be obtained.

According to the ninth aspect of the present invention, the same effects as in the third embodiment can be obtained.

While illustrative embodiments of the present invention have been described herein, the present invention is not limited to the various preferred embodiments described herein, but includes any and all embodiments having modifications, omissions, combinations (e.g., of aspects across various embodiments), adaptations and/or alterations as would be appreciated by those in the art based on the present disclosure. The limitations in the claims are to be interpreted broadly based the language employed in the claims and not limited to examples described in the present specification or during the prosecution of the application, which examples are to be construed as non-exclusive. For example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited.

### Industrial Applicability

The method for manufacturing the butt joint according to the present invention can be used in manufacturing a metal member for use in transportation apparatuses, electrical household appliances, industrial machinery or the like. The butt joint can be preferably used as such a metal member.

1. A manufacturing method of a butt joint, comprising:
disposing two joining members different in high temperature deformation resistance so as to abut against each other; and
performing friction stir joining by advancing a rotating probe of a joining tool along an abutting portion of the joining members with the rotating probe inserted in the abutting portion,
wherein the friction stir joining is performed in a state in which a rotational direction of the probe of the joining tool is set so as to coincide with a rotational direction rotating from one of the joining members having a lower high temperature deformation resistance toward the other of the joining members having a higher high temperature deformation resistance at a back side of a joining direction.

2. A manufacturing method of a butt joint, comprising:
disposing two joining members same in material but different in thickness so as to abut against each other with a step formed on upper surface sides of the joining members; and
performing friction stir joining by advancing a rotating probe of a joining tool along an abutting portion of the joining members with the rotating probe inserted in the abutting portion,
wherein the friction stir joining is performed in a state in which a rotational direction of the probe of the joining tool is set so as to coincide with a rotational direction rotating from one of the joining members having a thinner thickness toward the other of the joining members having a thicker thickness at a back side of a joining direction.

3. A manufacturing method of a butt joint, comprising:
preparing a first joining member of a high temperature deformation resistance Y1 and a thickness t1 and a second joining member of a high temperature deformation resistance Y2 and a thickness t2; and
performing friction stir joining by advancing a rotating probe of a joining tool along an abutting portion of the joining members with the rotating probe inserted in the abutting portion,
wherein, in cases where the joining members are disposed in an abutted manner in a state in which the joining members meet a relation of (Y1×t1)>(Y2×t2), the friction stir joining is performed in a state in which a rotational direction of the probe of the joining tool is set so as to coincide with a rotational direction rotating from the second joining member toward the first joining member at a back side of a joining direction, and
wherein, in cases where the joining members are disposed in an abutted manner in a state in which the joining members meet a relation of (Y1×t1)<(Y2×t2), the friction stir joining is performed in a state in which a rotational direction of the probe of the joining tool is set so as to coincide with a rotational direction rotating from the first joining member toward the second joining member at a back side of a joining direction

4. The manufacturing method of a butt joint according to claim 1, wherein the butt joint is a member to be used as a bending work material.

5. The manufacturing method of a butt joint according to claim 1, wherein the butt joint is a member to be used as a tailored blank member for manufacturing automobile parts.

6. A butt joint excellent in bendability obtained by the manufacturing method recited in claim 1.

7. A manufacturing method of a bent member which performs a bending operation to the butt joint obtained the manufacturing method recited in claim 1.

8. A butt joint formed by integrally joining two joining members abutted against each other by a friction stir joining method,
wherein one of the joining members has a high temperature deformation resistance Y1 and a thickness t1 and the other of the joining members has a high temperature deformation resistance Y2 and a thickness t2, and
wherein an undercut portion is formed on a surface of a friction stir joined portion at a side of one of the joining members having a larger value (Y1×t1) or (Y2×t2).

9. The butt joint as recited in claim 8, wherein the butt joint is a member to be used as a bending work material.

10. The but joint as recited in claim 8, wherein the butt joint is a member to be used as a tailored blank member for manufacturing automobile parts.

11. A friction stir joining method, comprising:
disposing two joining members different in high temperature deformation resistance so as to abut against each other; and
performing friction stir joining by advancing a rotating probe of a joining tool along an abutting portion of the joining members with the rotating probe inserted in the abutting portion,
wherein the friction stir joining is performed in a state in which a rotational direction of the probe of the joining tool is set so as to coincide with a rotational direction rotating from one of the joining members having a lower high temperature deformation resistance toward the other of the joining members having a higher high temperature deformation resistance at a back side of a joining direction.

12. A friction stir joining method, comprising:
disposing two joining members same in material but different in thickness so as to abut against each other with a step formed on upper surface sides of the joining members; and
performing friction stir joining by advancing a rotating probe of a joining tool along an abutting portion of the joining members with the rotating probe inserted in the abutting portion,
wherein the friction stir joining is performed in a state in which a rotational direction of the probe of the joining tool is set so as to coincide with a rotational direction rotating from one of the joining members having a thinner thickness toward the other of the joining members having a thicker thickness at a back side of a joining direction.

13. A friction stir joining method, comprising:
preparing a first joining member of a high temperature deformation resistance Y1 and a thickness t1 and a second joining member of a high temperature deformation resistance Y2 and a thickness t2; and
performing friction stir joining by advancing a rotating probe of a joining tool along an abutting portion of the joining members with the rotating probe inserted in the abutting portion,
wherein, in cases where the joining members are disposed in an abutted manner in a state in which the joining members meet a relation of (Y1×t1)>(Y2×t2), the friction stir joining is performed in a state in which a rotational direction of the probe of the joining tool is set so as to coincide with a rotational direction rotating from the second joining member toward the first joining member at a back side of a joining direction, and wherein, in cases where the joining members are disposed in an abutted manner in a state in which the joining members meet a relation of (Y1×t1)<(Y2×t2), the friction stir joining is performed in a state in which a rotational direction of the probe of the joining tool is set so as to coincide with a rotational direction rotating from the first joining member toward the second joining member at the back side of the joining direction.

14. The manufacturing method of a butt joint according to claim 2, wherein the butt joint is a member to be used as a bending work material.

15. The manufacturing method of a butt joint according to claim 3, wherein the butt joint is a member to be used as a bending work material.

16. The manufacturing method of a butt joint according to claim 2, wherein the butt joint is a member to be used as a tailored blank member for manufacturing automobile parts.

17. The manufacturing method of a butt joint according to claim 3, wherein the butt joint is a member to be used as a tailored blank member for manufacturing automobile parts.

18. A butt joint excellent in bendability obtained by the manufacturing method recited in claim 2.

19. A butt joint excellent in bendability obtained by the manufacturing method recited in claim 3.

20. A manufacturing method of a bent member which performs a bending operation to the butt joint obtained the manufacturing method recited in claim 2.

21. A manufacturing method of a bent member which performs a bending operation to the butt joint obtained the manufacturing method recited in claim 3.
